(19) United States
(12) Patent Application Publication
(10) Pub. No.: US 2014/0190307 A1
(43) Pub. Date: Jul. 10, 2014

(54) RAILCAR HANDBRAKE WHEEL

(71) Applicant: AMSTED RAIL COMPANY, INC., Chicago, IL (US)

(72) Inventors: KEVIN SKIBINSKI, Geneva, IL (US); Kyle Warren, Columbia, IL (US); Weiping Wang, Ballwin, MO (US); Nathan Reese, Troy, IL (US)

(73) Assignee: Amsted Rail Company, Inc., Chicago, IL (US)

(21) Appl. No.: 13/738,459

(22) Filed: Jan. 10, 2013

(51) Int. Cl. G05G 1/10

(52) U.S. Cl. CPC G05G 1/10
USPC 74/552

(57) ABSTRACT

A railcar handbrake wheel of polymeric composition including an outer ring connected to a hub by at least two spokes. The hub containing an insert or core molded into the hub. The core is a shaft member having a first end and a second end, with a head connected to the first end. The head on the first end of the core having a greater cross-sectional area than the second end of the core. The core containing an opening extending from the first end to the second end.

### BACKGROUND OF THE INVENTION

The invention relates generally to railway car handbrake systems, and more particularly to an improved polymeric handbrake wheel.

This invention is applicable to railcar handbrake apparatuses. A railcar handbrake is used to prevent railway cars from moving while they are not in use. The handbrake is engaged and disengaged manually by a railway worker. In a standard railway car handbrake apparatus, a handbrake wheel is fixed to an operating shaft that is rotatably attached to the gearbox of the handbrake. The handbrake apparatus is engaged or disengaged by rotating the handbrake wheel in a clockwise or counter-clockwise.

In the current railcar handbrake apparatus used in the railway industry, the handbrake wheel is made from stamped steel. The steel handbrake wheel is heavy, exerting unnecessary force caused by movement and vibrations of the wheel while the railcar is in use, on the gearbox and the rest of the apparatus. The steel handbrake wheel is also susceptible to damage during use, because steel is not a highly resilient material. The heaviness of the current steel handbrake wheel limits the number of wheels a railway worker can carry when performing repairs and replacing the handbrake wheels on the railway cars.

Both Ross Equipment Australia and LinkUp International produce non-steel, polymeric handbrake wheels. However, both of these products present additional problems not found when using steel handbrake wheels. The Ross polymeric handbrake wheel includes a small metal ring in the hub to connect the handbrake wheel to the shaft of the gearbox.

The LinkUp International polymer handbrake wheel has an insert made of aluminum that acts as a hub to connect the wheel to the shaft of the gearbox.

The present invention provides a polymeric handbrake wheel that has the necessary strength to function properly in everyday use, and increases the life of both the handbrake gearbox and the handbrake wheel.

### SUMMARY OF THE INVENTION

In accordance with the present invention, a polymeric railcar handbrake wheel with a metal insert or core is provided for use.

One embodiment of the present polymeric handbrake wheel includes an outer ring, a plurality of spokes, a hub, and an insert or a core. The hub is located inside the outer ring, and connected to the outer ring by the plurality of spokes. The core includes a shaft member with a first and a second end, with the first end having a head with a larger cross-sectional area than the second end. Both the first end and the second end of the core are secured in the hub. The core includes an opening in the head of the first end that extends through the core to the second end.

Another embodiment of the present polymeric handbrake wheel includes an outer ring, a plurality of spokes, a hub, and a core. The hub is located inside the outer ring, and connected to the outer ring by the plurality of spokes. The core includes a shaft member with first and a second end, with the first end having a larger cross-sectional area than the second end. The shaft member of the core contains at least one flange extending from the first end to the second end of the shaft member. Both the first end and the second end of the core are secured in the hub. The outer ring has a front face and a rear side, with the front face having reflectors, and the rear side having finger contours. The plurality of spokes have a plurality of front faces, with the front faces having reflectors. The core includes an opening in the first end that extends through the core to the second end. The hub includes a rear protruding hub with a plurality of flat faces on the outer surface of the rear protruding hub.

It is an object of the present invention to provide a polymeric handbrake wheel that can be used on all types of railcars to engage and disengage a railcar handbrake.

It is an object of the present invention to provide a polymeric handbrake wheel that is lighter and more durable than current steel handbrake wheels in the railway industry.

It is another object of the present invention to provide a polymeric handbrake wheel that has a higher resilience to impact, increasing the life of the handbrake wheel.

It is another object of the present invention to provide a polymeric handbrake wheel that increase the life of the handbrake gearbox.

It is yet another object of the present invention to provide a polymeric handbrake wheel that can withstand the torque necessary to engage and disengage a railcar handbrake.

It is a further object of the present invention to provide a polymeric handbrake wheel with a hub that will not crack or break during everyday use on a railcar.

It is a further object of the present invention to provide an insert or a core that prevents cracking of the insert or the core when the handbrake wheel is rotated on an operating shaft connected to the handbrake gearbox.

It is still a further object of the present invention to provide a narrow spoke design that will reduce the weight and simplify the mold tooling of the handbrake wheel.

It is still a further object of the present invention provide a rear protruding hub on a hub with flat areas for hammering when removing the handbrake wheel from the operating shaft connected to the handbrake gearbox.

It is still a further object of the present invention to provide a polymeric handbrake wheel that has an outer wheel or outer ring with finger contours for improved grip and ergonomics when rotating the wheel.

It is still a further object of the present invention to provide a polymeric handbrake wheel that includes reflectors on the face of the handbrake wheel.

### DESCRIPTION OF THE DRAWINGS

FIG. 1 is an isometric view of the polymeric handbrake wheel of the present invention;

FIG. 2 is a top plan view of the polymeric handbrake wheel of the present invention;

FIG. 3 is a side elevational view of the polymeric handbrake wheel of the present invention;

FIG. 4 is bottom plan view of the polymeric handbrake wheel of the present invention;

FIG. 5 is an isometric view of the insert or core of the polymeric handbrake wheel of the present invention;

FIG. 6 is a top plan view of the insert or core of the polymeric handbrake wheel of the present invention;

FIG. 7 is a side elevational view of the insert or core of the polymeric handbrake wheel of the present invention; and

FIG. 8 is a bottom plan view of the insert or core of the polymeric handbrake wheel of the present invention.

### DETAILED DESCRIPTION

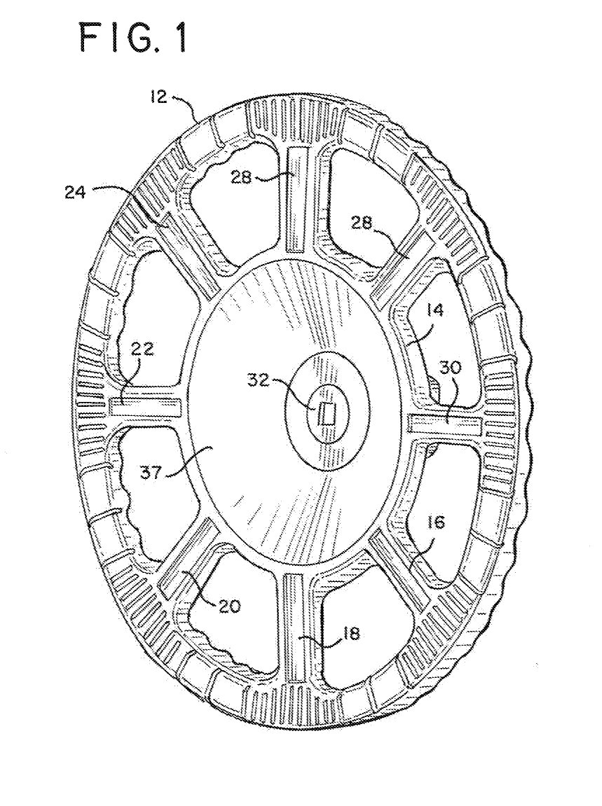

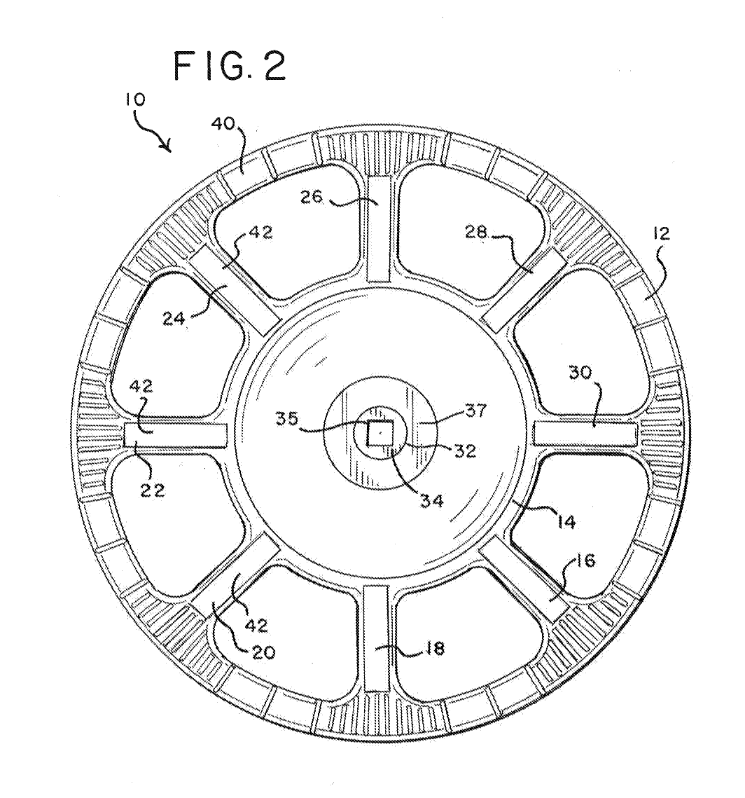

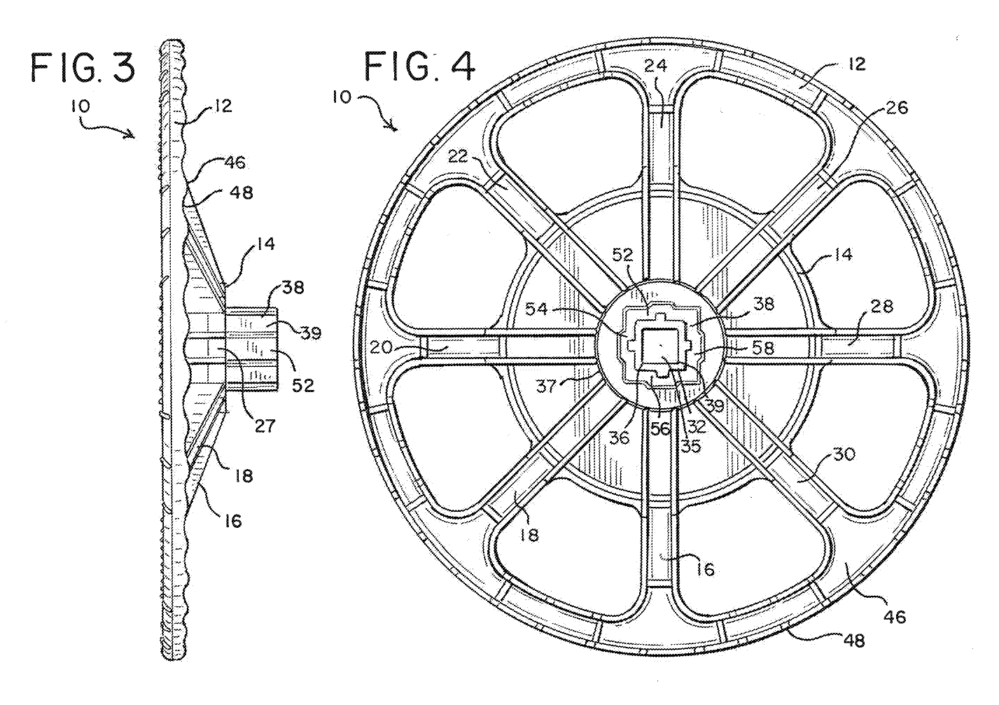

Referring now to FIGS. 1-4, a polymeric railcar handbrake wheel for operating a railcar handbrake is generally designated 10 and comprises an outer ring 12, a hub 14, and a plurality of spokes 16, 18, 20, 22, 24, 26, 28, 30. The hub 14 is located within the outer ring 12, and the hub 14 is connected to the outer ring 12 by the plurality of spokes 16, 18, 20, 22, 24, 26, 28, 30. The spokes generally extend downward at a slight angle from the front face 40 of the outer ring 12 in the axial direction, connecting with the hub 14 in a position where the hub 14 is slightly below the outer ring 12 in the axial direction. The hub 14 is generally round, and is fixed on an operating shaft (not shown) that is rotatably mounted on the railcar handbrake (not shown). However, it is contemplated that the hub 14 may be any other shape. The outer ring 12, the hub 14, and the plurality of spokes 16, 18, 20, 22, 24, 26, 28, 30 are all made from a polymeric material, preferably high density polyethylene (HDPE). However, other polymer materials may also be used.

The polymeric railcar handbrake wheel 10 is preferably made by a molding process. The narrow spoke design of the present invention reduces the weight of the handbrake wheel, while simplifying the mold tooling process. The preferable high density polyethylene material is significantly lighter than steel, while rigid enough to effectively transfer torque applied on the outer ring 12 of the handbrake wheel 10 to the operating shaft (not shown) of the railcar handbrake, when engaging or disengaging the handbrake. The significant weight reduction from the high density polyethylene handbrake wheel compared to the prior steel handbrake wheel, increases the life of the handbrake gearbox by reducing fatigue and wear on the gearbox caused by vibrations and movement of the handbrake wheel on the operating shaft while a railcar is in use. High density polyethylene has a higher resilience to impacts on the wheel during use, which prolongs the life of the railcar handbrake wheel compared to a steel handbrake wheel.

The hub 14 contains a center section 37 and a rear protruding hub 38. The rear protruding hub 38 is molded to the center section 37 of the hub 14 and extends in the axial direction on the operating shaft (not shown), towards the handbrake gearbox (not shown). The rear protruding hub 38 contains flat faces 52, 54, 56, 58 that are 90 degrees apart. The flat faces 52, 54, 56, 58 serve as receiving surfaces for a hammer or other tool when removing the handbrake wheel 10 from the operating shaft (not shown).

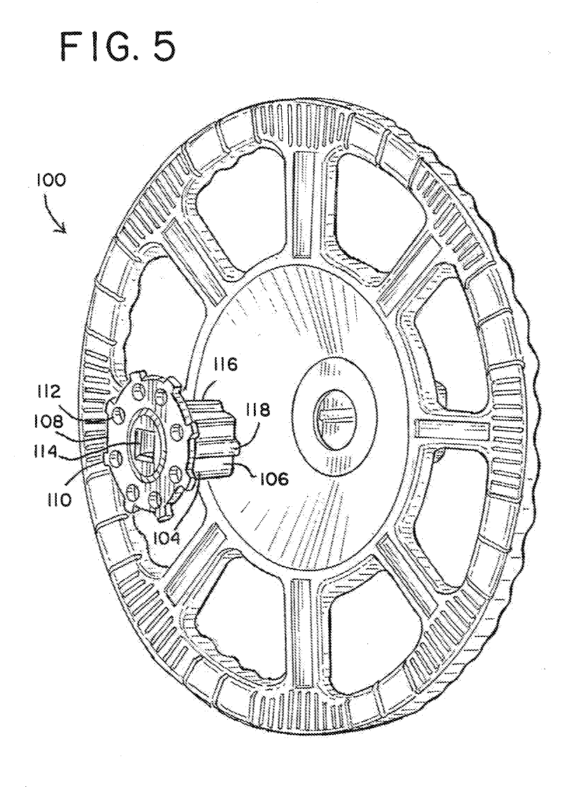

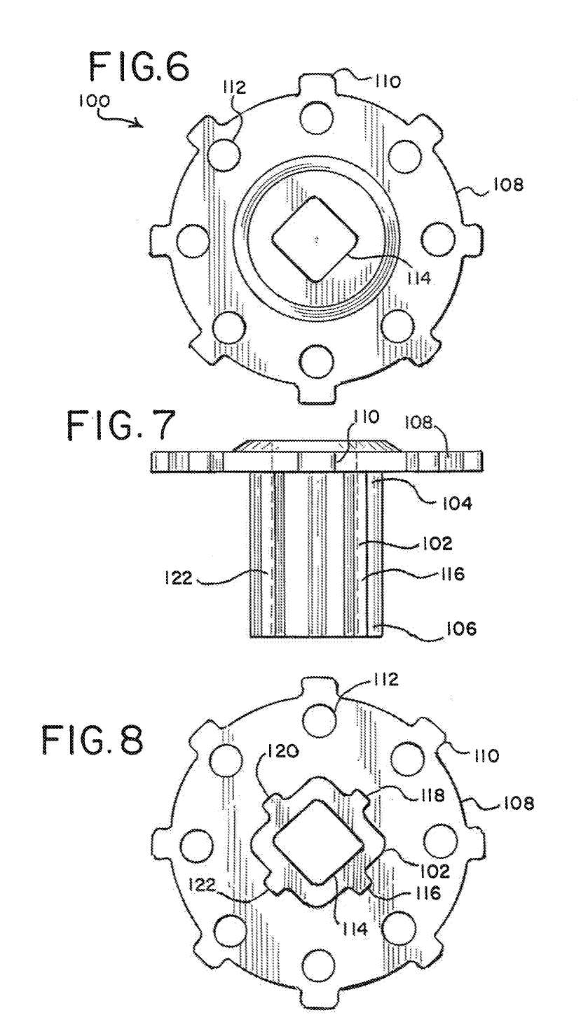

The center section 37 of the hub 14 contains a core or insert 32 that is molded into the hub 14. The core 32 is a shaft member (shown in FIGS. 5-8 as 102) that has a first end 34 that is molded into the center section 37 of the hub 14, and a second end 36 that is molded into the rear protruding hub 38, extending until it is flush with the end 39 of the rear protruding hub 38. The core 32 is embedded into the hub 14 during the molding process and is non-removable.

The core 32 contains an opening 35 that extends from the first end 34 to the second end 36. The opening 35 receives the operating shaft (not shown) from the handbrake gearbox, and fixes the handbrake wheel 10 on the operating shaft (not shown). The core 32 transfers torque placed on the outer ring 12 of the handbrake wheel 10 to the operating shaft (not shown), to engage or disengage the railcar handbrake. The core 32 can be made of any rigid material, but preferably, is made from powder metal. Powder metal is much stronger than prior aluminum cores, which prevents cracking or failure of the core during use. Production of the powder metal core is also a low cost process. Ferrous powder metal, especially steel, is preferred as the metal core. However, ductile cast iron may also be used for the metal core.

The front face 40 of the outer ring 12, and the front faces 42 of the spokes 16, 18, 20, 22, 24, 26, 28, 30 allows for reflectors to be installed or reflective paint to be applied to the front face 40 of the outer ring 12, and the front faces 42 of the spokes 16, 18, 20, 22, 24, 26, 28, 30 of the handbrake wheel 10, as required by law in certain countries. The rear 46 of the outer ring 12 has finger contours 48 that provide railway workers a secure grip when applying torque to the handbrake wheel 10.

Referring now to FIGS. 5-8, a polymeric railcar handbrake wheel core or insert is generally designated 100, and includes a shaft member 102 with a first end 104 and a second end 106. A head 108 is on the first end 104 of the shaft member 102. The head 108 has a larger cross-sectional area than the rest of the shaft member 102. The increased surface area of the head 108 of the core 100 enables the force the core 100 exerts on the hub 14 (FIGS. 1-4) to be spread over a greater area when torque is being applied to the handbrake wheel, preventing cracking and failure of the hub 14 (FIGS. 1-4) around the core 100. The increased surface area of the head 108 also provides for stronger mold between the huh 14 (FIGS. 1-4) and the core 100.

The head 108 contains extensions 110 or small protrusions from the head 108 that prevent the head 108 from being completely round. The head 108 also contains cutouts 112 or small holes. The extensions 110 and cutouts 112 on the head 108 of the core 100 ensure a stronger bond between the between the hub 14 (FIGS. 1-4) and the core 100 after the molding process is complete. The extensions 110 and cutouts 112 also prevent any movement or slippage of the core 100 in the hub 14 (FIGS. 1-4) during use.

The core 100 contains flanges 116, 118, 120, 122 that extend along the shaft member 102, from the second end 106 of the shaft 102 to the first end 104 of the shaft 102. The flanges 116, 118, 120, 122 prevent rotation of the core 100 or wheel slippage after the core 100 is molded into the hub 14 (FIGS. 1-4), when torque is exerted on the core 100 and hub 14 (FIGS. 1-4) during use.

The shaft member 102 contains an opening 114 that extends from the head 108 on the first end 104 of the shaft t ember 102, through the second end 106 of the shaft member 102. The opening 114 is generally square shaped, but any other shape opening is also contemplated to allow the opening 114 to receive the operating shaft (not shown) of the railcar handbrake,

While particular embodiments of the present invention have been illustrated and described herein, it will be appreciated by those skilled in the art that changes and modifications may be made thereto without departing from the invention in its broader aspects.

What is claimed is:

1. A railcar handbrake wheel of polymeric composition comprising:
an outer ring;
at least two spokes;
a hub;
a core;
wherein said core has a shaft with a first end and a second end, said first end having a head, and said core containing an opening extending, from said head on said first end, through said shaft, to said second end;
wherein said hub is centered inside said outer ring, and connected to said outer ring by said at least two spokes, and said core secured into said hub.

2. The railcar handbrake wheel of polymeric composition of claim 1, said outer ring, said at least two spokes, and said hub being high density polyethylene.

3. The railcar handbrake wheel of polymeric composition of claim 1, said core being powder metal.

4. The railcar handbrake wheel of polymeric composition of claim 1, wherein said core has an outer surface containing at least one flange, extending from said second end to said first end of said shaft.

5. The railcar handbrake wheel of polymeric composition of claim 1, wherein said hub contains a rear protruding hub, said rear protruding hub containing at least one flat face.

6. The railcar handbrake wheel of polymeric composition of claim 1, wherein said outer ring has a front face and a rear side, said rear side containing finger contours.

7. The railcar handbrake wheel of polymeric composition of claim 6, wherein said front face of said outer ring contain means for reflecting light.

8. The railcar handbrake wheel of polymeric composition of claim 1, wherein said at least two spokes have at least two front faces, said at least two front faces containing means for reflecting light.

9. A railcar handbrake wheel of polymeric composition comprising:
an outer ring;
a plurality of spokes;
a hub;
a core;
wherein said core is a shaft with a first and a second end, said first end having a larger cross-sectional area than said second end, said core having an opening extending from said first end, through said shaft, to said second end;
wherein said hub is centered inside said outer ring, and connected to said outer ring by said plurality of spokes, and said core secured into said hub.

10. The railcar handbrake wheel of polymeric composition of claim 9, said outer ring, said plurality of spokes, and said hub being high density polyethylene.

11. The railcar handbrake wheel of polymeric composition of claim 9, said core being powder metal.

12. The railcar handbrake wheel of polymeric composition of claim 9, wherein said core has an outer surface containing at least one flange, extending from said second end to said first end of said shaft.

13. The railcar handbrake wheel of polymeric composition of claim 9, wherein said hub contains a rear protruding hub, said rear protruding hub containing at least one flat face.

14. The railcar handbrake wheel of polymeric composition of claim 9, wherein said outer ring has a front face and a rear side, said rear side containing finger contours.

15. The railcar handbrake wheel of polymeric composition of claim 14, wherein said front face of said outer ring contains a means for reflecting light.

16. The railcar handbrake wheel of polymeric composition of claim 9, wherein said plurality of spokes have a plurality of front faces, said plurality of front faces containing means for reflecting light.

17. A railcar handbrake wheel of polymeric composition comprising:
an outer ring;
a plurality of spokes;
a hub;
a insert containing a first and a second end;
wherein said insert contains a hole that extends from said first end to said second end;
wherein said hub is centered inside said outer ring, and connected to said outer ring by said plurality of spokes, and said insert secured into said hub.

18. The railcar handbrake Wheel of polymeric composition of claim 17, wherein said insert has a head attached to said first end, said head having a larger cross-sectional area than said second end.
